(19) United States
(12) Patent Application Publication
(10) Pub. No.: US 2021/0099113 A1
(43) Pub. Date: Apr. 1, 2021

(54) ROTATION DIRECTION CONTROL STRUCTURE OF ELECTRIC TOOLS

(71) Applicant: TECHWAY INDUSTRIAL CO., LTD., Taichung City (TW)

(72) Inventors: Fu-Hsiang CHUNG, Taichung City (TW); Shih Ying SU, Taichung City (TW)

(21) Appl. No.: 17/025,103

(22) Filed: Sep. 18, 2020

(30) Foreign Application Priority Data
Sep. 30, 2019 (TW) 108135392

(51) Int. Cl. H02P 7/03; B25F 5/02; H02P 3/08

(52) U.S. Cl. CPC H02P 7/03; H02P 3/08; B25F 5/02

(57) ABSTRACT

The invention is a rotation direction control structure of electric tools, which includes: a main body with a motor disposed inside; a control unit electrically connected to the motor of the main body and capable of controlling rotational direction and speed of the motor, the control unit is connected to a sensing unit to sense rotational direction and speed of the motor; in addition, the control unit is connected with a switch and a commutation module to control rotation and direction switching of the motor respectively; after the commutation module generates a commutating signal, the control unit drives the motor to decelerate, after the sensing unit detects that a motor speed is zero, the control unit drives the motor to rotate in a opposite direction, and through the commutation module, an electric tool is capable of performing commutating action during operation.

### BACKGROUND OF THE INVENTION

### Field of Invention

The invention relates to electric tools, and more particularly to a rotation direction control structure of electric tools capable of controlling forward and reverse rotations through electronic buttons.

### Related Art

Conventional electric tools are mainly rotated by an internal motor to directly or indirectly drive a workpiece to rotate forwardly or reversely. The electric tool is provided with a commutation pin, switching of rotational direction of the motor can be achieved by toggling the commutation pin.

However, in order to facilitate the commutative action, the commutation pin will protrude from the electric tool so that the user can easily touch to perform the switching action. However, in addition to the commutation operation, the commutation pin can also be easily touched unintentionally during operation to cause damage to the workpiece. Furthermore, the commutation pin is a mechanical structure, which will cause abrasion after long-term use, and will easily malfunction after use. Moreover, dust will be generated during the operation of the electric tool and also from the environment, and dust will accumulate in gaps between the commutation pin and the electric tool, and the commutation pin can be stuck to be incapable of performing switching smoothly.

In addition, in order to avoid accidental touch during operation to cause instantaneous commutation and damage to the machine, when the commutation pin needs to be switched, it is necessary to stop the action of the motor before performing commutative action of the commutation pin. Therefore, if frequent switching of directions is required, such an operation will be quite time consuming.

### SUMMARY OF THE INVENTION

An object of the invention is to provide a rotation direction control structure of electric tools capable of simply and conveniently switching rotation direction of electric tools.

Another object of the invention is to provide a rotation direction control structure of electric tools capable of safely switching operating directions of electric tools during operation of the electric tools, and avoiding damage to the electric tools.

Yet another object of the invention is to provide a rotation direction control structure of electric tools in which a commutation module for switching operating directions of the electric tools is in the form of an electronic button.

In order to achieve the above objects, the invention provides a rotation direction control structure of electric tools including:
a main body with a motor disposed inside;
a control unit electrically connected to the motor of the main body and capable of controlling rotational direction and speed of the motor;
a sensing unit electrically connected to the control unit and capable of sensing rotational direction and speed of the motor;
a switch electrically connected to the control unit and capable of generating an operation signal, and the operation signal causes the control unit to drive the motor to rotate or stop; and
a commutation module electrically connected to the control unit, after the commutation module is triggered, a commutating signal can be generated to cause the control unit to control the motor to switch direction, after the commutation module generates the commutating signal, the control unit decelerates the motor, after the sensing unit detects that a motor speed is zero, the control unit drives the motor to rotate in an opposite direction to avoid damage to the motor caused by instantaneous switching of rotational direction of the motor due to unintentional touches.

Thereby, a user is capable of switching an operating direction of an electric tool through the commutation module, and the operation is convenient and fast. Even if when the electric tool is operating, the control unit decelerates the motor when the motor is being switched between forward and reverse rotations, after the motor stops, the motor is caused to rotate in an opposite direction to ensure safe operation and avoid damage to the electric tool.

Preferably, the commutation module is an electronic button, which is dustproof, and the electronic button replaces the conventional mechanical commutation structure, which can free up space for electric tools and is advantageous for space utilization and wiring.

Preferably, the commutation module is composed of two electronic buttons, one of which is for forward rotation control, and another is for reverse rotation control.

In the rotation direction control structure of electric tools provided by the invention, a commutation module does not need to protrude from the main body to operate, and in the process of operation, after the motor is stopped, switching rotation direction is performed to avoid damage to the electric tools or workpieces caused by commutating under high-speed operation.

### BRIEF DESCRIPTION OF THE DRAWINGS

In order to enable the examiner to further understand the objects, features, and achieved efficacies of the invention, two preferred embodiments are listed below for detailed explanation in conjunction with the drawings, wherein:

FIG. 1 is a perspective view of a preferred embodiment of the invention;

FIG. 2 is a block diagram of connection of the preferred embodiment of the invention;

FIG. 3 is a flow chart of operation of the preferred embodiment of the invention;

FIG. 4 is a perspective view of a second preferred embodiment of the invention;

and

FIG. 5 is a block diagram of connection of the preferred embodiment of the invention.

### DETAILED DESCRIPTION OF THE INVENTION

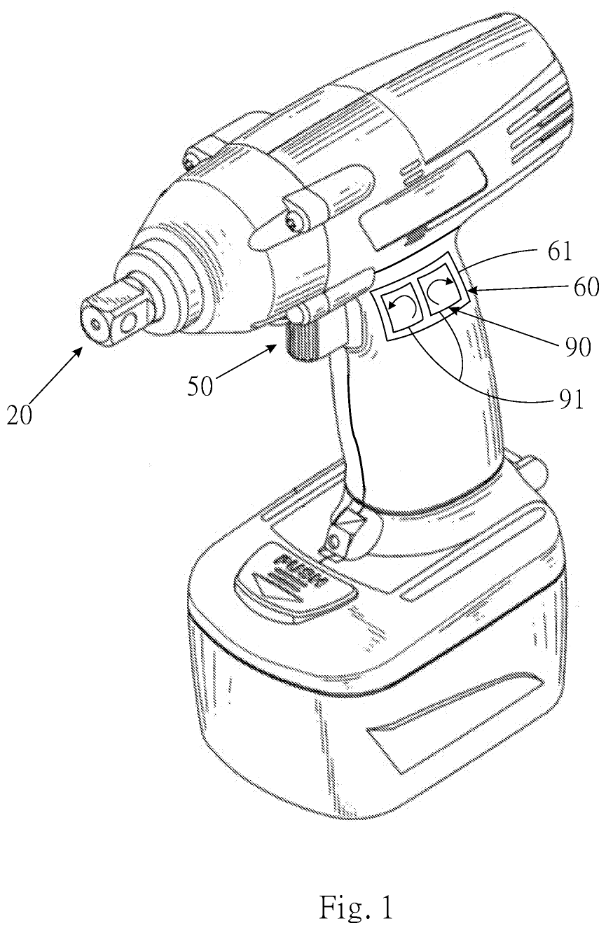

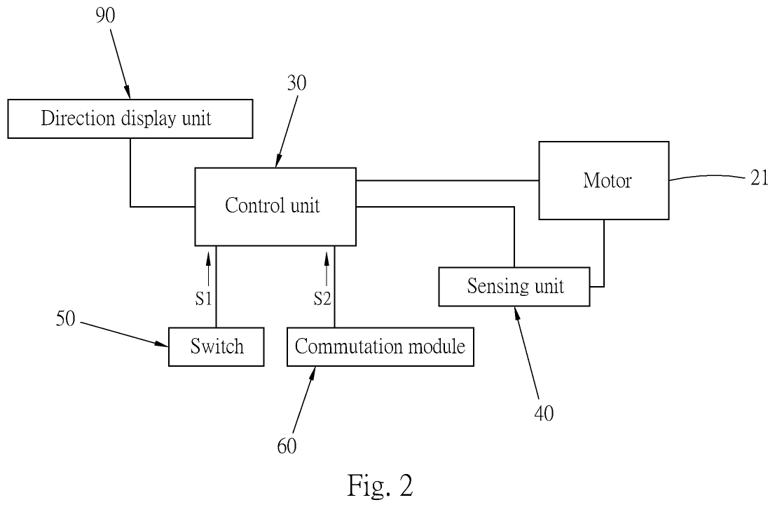

Please refer to FIGS. 1 and 2, which are an electric tool 10 provided by a preferred embodiment of the invention, which includes:
a main body 20 provided with a motor 21 inside, and capable of directly or indirectly driving a workpiece to rotate, driving can be performed directly or torque can be increased through a gear mechanism, the motor is a conventional structure and thus will not be described herein;
a control unit 30 electrically connected to the motor 21 of the main body 20 to be capable of controlling rotational direction and speed of the motor 21, the control unit 30 is basically disposed inside the main body 20, the control unit 30 is built with related control programs, various controls can be performed on the motor 21 through the programs in the control unit 30, including programs for braking the motor 21 to decelerate the motor;
a sensing unit 40 electrically connected to the control unit 30, being a current detector capable of detecting magnitude and direction of a current applied to the motor 21, and capable of sensing rotational direction and speed of the motor 21, types of the sensing unit 40 being used are not limited, any commonly used sensing units that are capable of sensing rotational direction and speed of the motor 21 are applicable;
a switch 50 electrically connected to the control unit 30, when the switch 50 is pressed, an operation signal S1 can be generated, after the control unit 30 receives the operation signal S1 of the switch 50, the motor 21 is driven to rotate in a first direction, when the switch 50 being released, the operation signal S1 stops, and the control unit 30 stops driving the motor 21 to rotate; and
a commutation module 60 disposed on an outer side of the main body 20 and electrically connected to the control unit 30, the commutation module 60 in this embodiment is composed of an electronic button 61, the button 61 can be composed of an electronic button such as membrane button, touch button or switch button, in addition to its small size and can be attached to a surface of the main body 20 and is not easy to be touched unintentionally, the commutation module 60 can be disposed at a position where a commutation device of a conventional electric tool is disposed, in addition to allowing a user to quickly adapt to the usage, the position vacated by the conventional commutation device can also be used for wiring of the electric tool of the invention, which can reduce the expenses and troubles of redesigning a mold, it is not easy for the electronic button 61 to have contact with the external environment when being used, and is less likely to cause damage, and the electronic button 61 is less likely to wear out due to long-term use or to accumulate dust in gaps to cause problems in switching; after the button 61 is pressed, a commutating signal S2 can be generated to be provided for the control unit 30, so that the control unit 30 will prepare for commutating, after the control unit 30 receives the commutating signal S2 of the electronic button 61, the control unit 30 firstly apply a step-down action, so that an operating voltage of the motor 21 drops to about 10%-30% of an original operating voltage, in this embodiment, it is set to 20%, after it drops to 20% of the original operating voltage, the control unit 30 controls the motor 21 to generate a braking action, and the motor 21 is driven to decelerate and to gradually stop rotating, and the sensing unit 40 is used to detect whether the motor 21 has stopped rotating.

For the braking action of the control unit 30 after the voltage is reduced, in addition to having a brake program built into the programs of the control unit 30, and electronically controlling the motor 21 to perform the braking action, a mechanical brake device (not shown in the figures) can also be installed, the brake device is electrically connected to the control unit 30, and can be actuated by the control unit 30 to apply a frictional force to the motor 21, so that the motor 21 is subjected to action of the frictional force to decelerate and stop rotating.

A direction display unit 90 is provided on the commutation module 60 and electrically connected to the control unit 30. In this embodiment, the direction display unit 90 is composed of an illuminator 91, the illuminator 91 can indicate direction of rotation by light changes, or display direction of rotation through changes in color to display changes between forward and reverse rotations. In addition, the direction display unit 90 can also be separately installed at any position on the main body 20, such as installed on a top surface or at a rear position of an outer periphery of the main body 20 to be convenient for the user to observe (the direction display unit 90 can be installed independently).

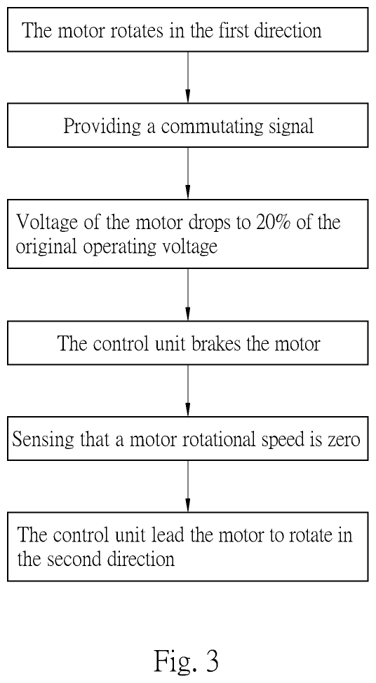

Please refer to FIGS. 1 to 3 for operation. The user holds the main body 20 of the electric tool 10 and presses the switch 50 continuously. The switch 50 can continuously generate the operation signal S1 to be provided for the control unit 30. The control unit 30 can make the motor 21 continuously rotate in a first direction, such as forward rotation, that is, clockwise rotation. Direction and speed of rotation are sensed by the sensing unit 40, and the direction display unit 90 will display the motor 21 rotating clockwise. When the switch 50 being released, the operation signal S1 stops, and the control unit 30 no longer drives the motor 21 to rotate.

When the motor 21 of the electric tool 10 is to be restarted from stopped state, after the switch 50 is pressed, the operation signal S1 is transmitted to the control unit 30, and the control unit 30 drives the motor 21 to rotate again in a same direction before stop rotating, that is, if the rotation is clockwise before stopping, the motor 21 will still rotate in the clockwise direction after restarting to operate. If it is not sure about the direction of operation before stopping or commutating action is required, the button 61 of the commutation module 60 can be pressed before pressing the switch 50 to make the direction display unit 90 display the current direction of rotation. If the direction meets the requirement, the switch 50 can be pressed; if direction of rotation needs to be switched, the button 61 can be pressed again to generate the commutating signal S2 to be provided for the control unit 30, so that the control unit 30 can drive the motor 21 in an opposite direction.

If commutating action is performed when the motor 21 is rotating, press the button 61 of the commutation module 60, and the button 61 will generate the commutating signal S2. At this time, the switch 50 is still pressed continuously (i.e. the switch 50 is still in the ON state), the control unit 30 continues to drive the motor 21 to rotate to keep the motor 21 rotating, and the control unit 30 will gradually decrease a voltage passing through the motor 21. At this time, the motor 21 still maintains rotating clockwise as the first direction, after the voltage drops to 20% of an original voltage, the control unit 30 brakes the motor 21 to generate a braking action, so that a rotational speed of the motor 21 is reduced to zero to stop rotating.

When the current detector of the sensing unit 40 detects a state of current of the motor 21 and confirms that a rotational speed of the motor 21 is zero; the control unit 30 will drive the motor 21 to generate a second direction of rotation opposite to the first rotational direction, that is, to generate reverse rotation to rotate counterclockwise. When the sensing unit 40 detects that a rotational direction of the motor 21 is changed, the control unit 30 makes the direction display unit 90 to another direction indication, that is, an indication of counterclockwise rotation.

When the motor 21 is to be switched from the counterclockwise direction to the clockwise direction again, the user can touch the button 61 of the commutation module 60 again to make the button 61 generate the commutating signal S2 to be provided for the control unit 30, leading the control unit 30 to perform a commutating procedure again.

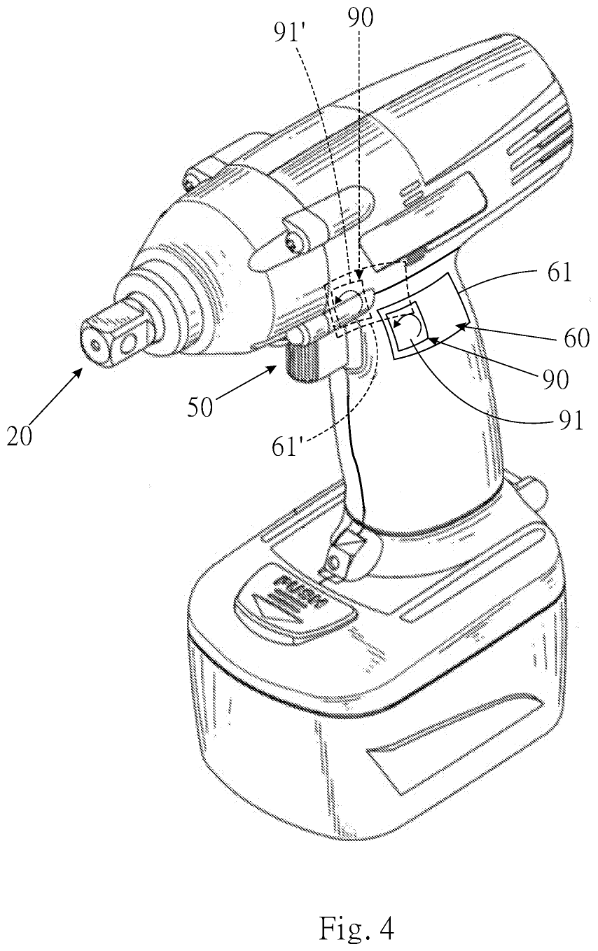

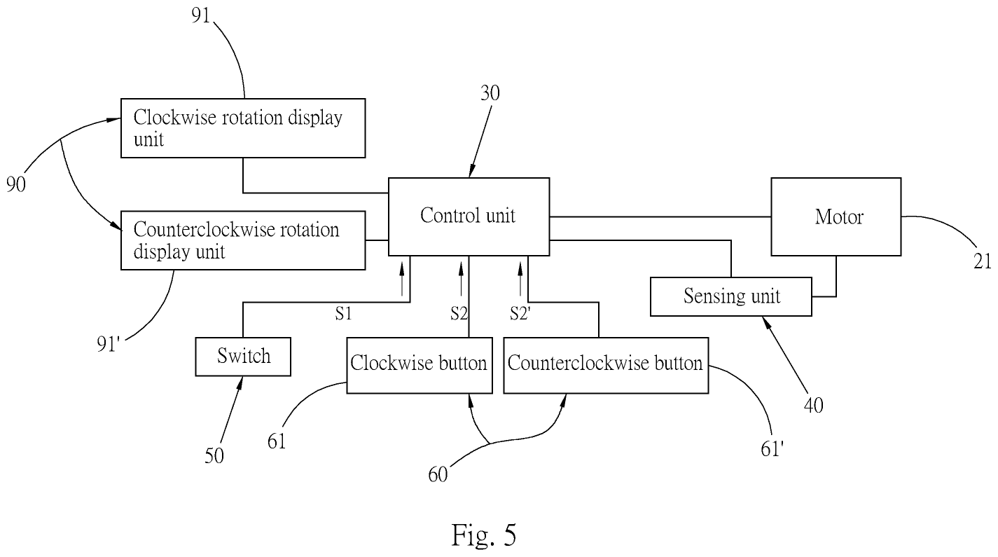

Please refer to FIGS. 4 and 5, which are a second preferred embodiment of the electric tool 10 provided by the invention. The main structure is the same as that of the first preferred embodiment, and the same components use the same reference numerals, which will not be described again, wherein:
the commutation module 60 has two electronic buttons 61, 61′. The two buttons 61, 61′ are respectively disposed on left and right sides of the main body 20. the buttons 61 controls forward rotation to rotate in clockwise direction. When the button 61 is pressed, the commutating signal S2 is generated, and the other button 61′ controls reverse rotation to rotate in counterclockwise direction. When the button 61′ is pressed, a commutating signal S2′ is generated. The direction display unit 90 is also provided with two luminous bodies 91, 91′, the two illuminator 91, 91′ are respectively disposed on the two buttons 61, 61′, and the direction display unit 90 can also be disposed at any position on an outer peripheral side on the main body 20 as required.

The two buttons 61, 61′ generate the different commutating signals S2, S2′ to be provided for the control unit 30. If the motor 21 originally rotates clockwise, and the button 61 that controls clockwise rotation is pressed again, the generated clockwise commutating signal S2 is incapable of making the control unit 30 to perform a commutating procedure. The button 61′ for controlling counterclockwise rotation needs to be pressed, and the counterclockwise commutating signal S2′ will drive the control unit 30 to perform the commutating procedure. Furthermore, the two illuminator 91, 91′ of the direction display unit 90 will show clockwise rotation or counterclockwise rotation respectively, and the user can observe the rotational direction through the illuminator 91, 91′ disposed on the different buttons 61, 61′. When the motor 21 rotates in counterclockwise direction, the counterclockwise commutating signal S2′ generated by pressing the button 61′ controlling counterclockwise rotation is incapable of leading the control unit 30 to perform a commutating action on the motor 21, the button 61 for controlling clockwise rotation needs to be pressed, and the clockwise commutating signal S2 generated will lead the control unit 30 to generate a commutating rotation on the motor 21, that is, a clockwise rotation.

The commutation module of the rotation direction control structure of electric tools provided by the invention is an electronic button design, which is less likely to contact with the external environment. In addition to avoiding damage and misoperation, the electronic button is also relatively hard to wear out and does not have the problem of unable to be pushed caused by dust accumulated in gaps. Moreover, when the control unit performs the commutating procedure, the control unit will first confirm whether the motor speed is reset to zero before performing commutating. Compared with conventional electric tools, with the mechanical commutation pin being incapable of directly performing the commutating action when the motor is running, the control unit of the invention is capable of confirming that the motor is completely stationary before commutating, which can ensure the integrity and safety of the electric tool and the workpiece, and avoid damage. By using the electric tool of the invention, the operating direction of the electric tool can be conveniently and quickly switched, and even if the motor of the electric tool is in rotating, the commutating operation can still be performed.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A rotation direction control structure of electric tools comprising:
a main body with a motor disposed inside;
a control unit electrically connected to the motor of the main body and capable of controlling rotational direction and speed of the motor;
a sensing unit electrically connected to the control unit and capable of sensing rotational direction and speed of the motor;
a switch electrically connected to the control unit and capable of generating an operation signal, and the operation signal causing the control unit to drive the motor to rotate or stop; and
a commutation module electrically connected to the control unit, after the commutation module being triggered, a commutating signal being generated to cause the control unit to control the motor to switch direction, after the commutation module generating the reversing signal, the control unit decelerating the motor, after the sensing unit detecting that a motor speed being zero, the control unit driving the motor to rotate in an opposite direction.

2. The rotation direction control structure as claimed in claim 1, wherein the commutation module has an electronic button, and button is capable of controlling forward and reverse rotations.

3. The rotation direction control structure as claimed in claim 1, wherein the commutation module has two electronic buttons, one of the buttons controls forward rotation, and the other button controls reverse rotation.

4. The rotation direction control structure as claimed in claim 2, wherein the button is either a membrane button, a touch button or a press button.

5. The rotation direction control structure as claimed in claim 3, wherein the button is either a membrane button, a touch button or a press button.

6. The rotation direction control structure as claimed in claim 1, wherein when the commutation module generates the commutating signal, the control unit applies a step-down action to reduce a voltage to 10%-30% of an original voltage, after the voltage drops to the range, the control unit performs a braking action to decelerate the motor.

7. The rotation direction control structure as claimed in claim 1, further including at least one direction display unit, and the direction display unit being electrically connected to the control unit to display rotational direction of the motor.

8. The rotation direction control structure as claimed in claim 1, wherein the sensing unit is a current detector.

9. The rotation direction control structure as claimed in claim 1, wherein when the control unit keeps the motor operating, the commutating signal is activated to make the motor rotate in opposite direction.

10. The rotation direction control structure as claimed in claim 1, wherein a brake program is built in the control unit to decelerate the motor.

11. The rotation direction control structure as claimed in claim 6, wherein a brake program is built in the control unit to decelerate the motor.

12. The forward and reverse rotation control structure as claimed in claim 1, wherein the control unit is electrically connected with a braking device, and the braking device is used to decelerate the motor.

13. The forward and reverse rotation control structure as claimed in claim 6, wherein the control unit is electrically connected with a braking device, and the braking device is used to decelerate the motor.
